(19) United States
(12) Patent Application Publication
(10) Pub. No.: US 2015/0113027 A1
(43) Pub. Date: Apr. 23, 2015

(54) METHOD FOR DETERMINING A LOGARITHMIC FUNCTIONAL UNIT

(71) Applicant: National Tsing Hua University, Hsinchu (TW)

(72) Inventors: SHIN KAI CHEN, KAOHSIUNG CITY (TW); TING YAO HSU, TAICHUNG CITY (TW); TSUNG CHING LIN, TAIPEI CITY (TW); CHIH WEI LIU, HSINCHU CITY (TW); JENQ KUEN LEE, HSINCHU (TW)

(73) Assignee: NATIONAL TSING HUA UNIVERSITY, HSINCHU (TW)

(21) Appl. No.: 14/060,330

(22) Filed: Oct. 22, 2013

(51) Int. Cl. G06F 7/483

(52) U.S. Cl. CPC G06F 7/483
USPC 708/204

(57) ABSTRACT

A method for determining a logarithmic functional unit comprises providing a segment number; using the segment number to determine a piecewise linear approximation on a plurality of corresponding intervals for approximating a function for converting a fraction; providing a bit precision; converting endpoints separating the plurality of intervals to corresponding binary endpoints separating an additional plurality of intervals in the bit precision; determining an adjusted piecewise linear approximation that has an approximation error less than a threshold and is on the additional plurality of intervals; encoding coefficients of the adjusted piecewise linear approximation; determining a less precise approximation from the adjusted piecewise linear approximation as a candidate linear approximation, wherein the less precise approximation uses an argument value having a least bit-width while still being able to have an approximation error less than the threshold; and implementing the less precise approximation to obtain an implementation circuit.

### BACKGROUND OF THE INVENTION

1. Field of the Invention

The present invention relates to a method for determining a logarithmic functional unit.

2. Description of the Related Art

Real-time three-dimensional graphics applications are commonly applied in the computing world. In order to handle the three-dimensional graphics applications, computing devices need three-dimensional graphics processors. A three-dimensional graphics processor is designed to perform heavy arithmetic calculations such as division, reciprocals, square-roots, squares, and powering calculations. A study shows that these heavy calculations may consume up to 83% of total processing time. Moreover, the real-time three-dimensional graphics applications not only need processing time, but also consume more electrical power.

Real-time three-dimensional graphics applications are also introduced in mobile devices such as smart phones and tablet personal computers. However, the mobile devices have lower computing capabilities and a limited electrical power supply. In order to smoothly apply the real-time three-dimensional graphics applications on mobile devices, the heavy calculations have to be optimized for the mobile devices so that less electrical power is needed in order to generate acceptable results. However, the present optimization solutions are not perfect.

### SUMMARY OF THE INVENTION

In one embodiment of the present invention, a hardware implemented method for determining a logarithmic functional unit comprises providing a segment number; using the segment number to determine a piecewise linear approximation on a plurality of corresponding intervals for approximating a function for converting a fraction; providing a bit precision; converting endpoints separating the plurality of intervals to corresponding binary endpoints separating an additional plurality of intervals in the bit precision; determining an adjusted piecewise linear approximation that has an approximation error less than a threshold and is on the additional plurality of intervals; encoding coefficients of the adjusted piecewise linear approximation; determining a less precise approximation from the adjusted piecewise linear approximation as a candidate linear approximation, wherein the less precise approximation uses an argument value having a least bit-width while still being able to have an approximation error less than the threshold; and implementing the less precise approximation to obtain an implementation circuit.

In one embodiment of the present invention, a computer program product comprises a non-transitory computer-readable medium bearing computer program code embodied therein for causing a hardware computer system to perform the above steps.

### BRIEF DESCRIPTION OF THE DRAWINGS

The objectives and advantages of the present invention will become apparent upon reading the following description and upon referring to the accompanying drawings in which:

FIG. 1 schematically shows a logarithmic function unit (LFU) according to one embodiment of the present invention;

FIG. 2 schematically shows an architecture of a logarithmic converter according to one embodiment of the present invention;

FIG. 3 schematically shows a logarithmic approximation architecture according to one embodiment of the present invention;

FIG. 4 schematically shows an add and shift architecture according to one embodiment of the present invention;

FIG. 5 is a flow chart showing a method for determining a logarithmic functional unit according to one embodiment of the present invention;

FIG. 6 is a flow chart showing a method for determining a minimum segment according to one embodiment of the present invention;

FIG. 7 is a flow chart showing a method for hardware decisions and resource estimations according to one embodiment of the present invention;

FIG. 8 is a flow chart showing a method for determining adder bit-width and an adder number for an add and shift architecture according to one embodiment of the present invention; and

FIG. 9 schematically shows a hardware computer system according to one embodiment of the present invention.

### DETAILED DESCRIPTION OF THE INVENTION

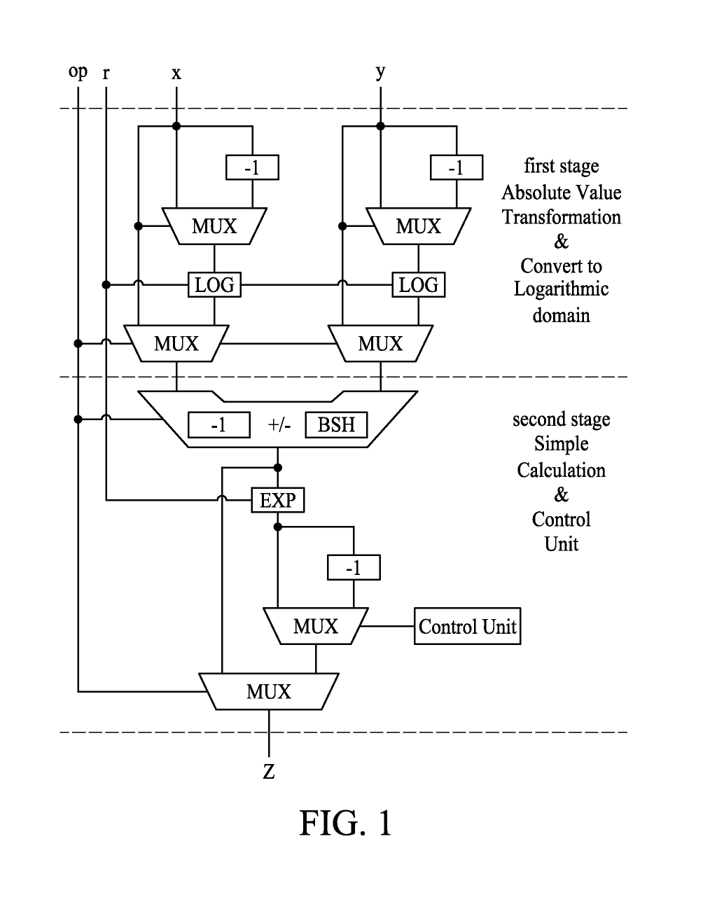

FIG. 1 schematically shows a logarithmic function unit (LFU) according to one embodiment of the present invention. Referring to FIG. 1, the logarithmic function unit 1 comprises two absolute circuits and two binary logarithmic converters (LOGs) in a first stage. The logarithmic function unit 1 comprises a simple arithmetic logic unit, a binary antilogarithmic converter, and a complement circuit in a second stage. The simple arithmetic logic unit comprises an inverter, and adder/subtractor, and a barrel shifter (BSH). The LFU 1 is pipelined for fast operations.

The LFU 1 comprises a control unit configured to ensure that the result z can have a correct sign. The operations of the control unit are shown in Table I below.

TABLE I
Control Unit

| op | x sign bit | y sign bit | output selection |
|---|---|---|---|
| multiplication | 0 | 0 | exp result |
| or | 0 | 1 | exp result X (−1) |
| division | 1 | 0 | exp result X (−1) |
| | 1 | 1 | exp result |
| reciprocal | 0 | N.A. | exp result |
| | 1 | | exp result X (−1) |

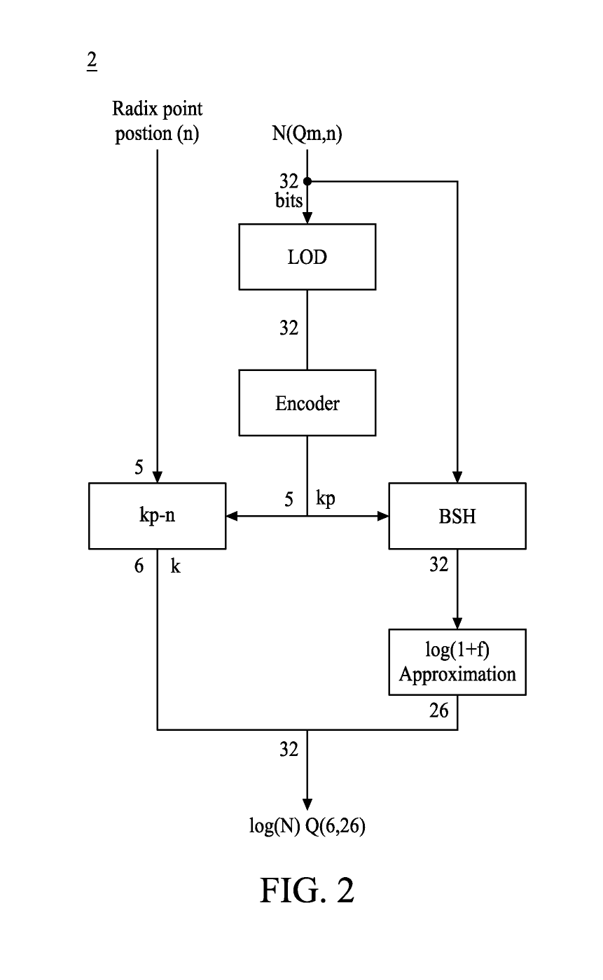

FIG. 2 schematically shows an architecture of a logarithmic converter according to one embodiment of the present invention. Referring to FIG. 2, a logarithmic converter 2 comprises a leading one detector (LOD) circuit and a barrel shifter (BSH). If N is a binary number and is represented by:

N=zₖ . . . z₂z₁z₀·z₋₁z₋₂z₋₃ . . . zⱼ. (1)

where zᵢ=0 or 1 and zₖ=1

Through a logarithmic conversion, the N can be expressed as:

log₂N=k+log₂(1+f) (2)

where k is an integer and 0≦f<1.

N can be in a fixed point hybrid number format Q(m,n), wherein in is the number of bits for designating the two's complement integer portion of the number N, and n is the number of bits for designating the fractional portion of the number N.

The LOD circuit is configured to determine the number k. The LOD circuit only passes a leading bit to an output while maintaining the position of the leading bit. A typical LOD circuit can be found in a paper by K. H. Abed and R. E. Sifred, entitled “CMOS VLSI implementation of a low power logarithmic converter,” IEEE Trans. On Computers, 2003, whose relevant disclosure is incorporated herein for reference.

Referring to FIG. 2, the input value N is then passed to the BSH to obtain (1+f)

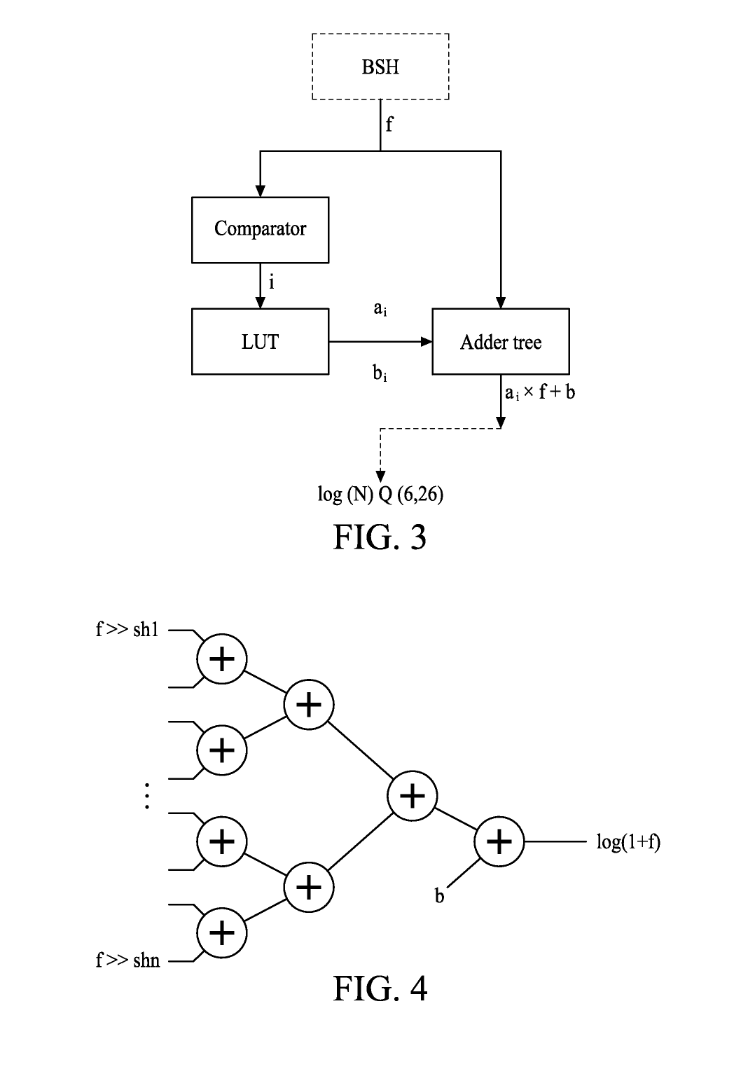

FIG. 3 schematically shows a logarithmic approximation architecture according to one embodiment of the present invention. The log₂ (1+f) can be implemented as a logarithmic approximation architecture (or a logarithmic functional unit) as shown in FIG. 3. The log₂(1+f) can be further represented by aᵢ×f+bᵢ, and the comparator and the look-up table are applied to determine the aᵢ and bᵢ.

The function log₂(1+f) can be approximated by a piecewise linear approximation. The linear equations of the piecewise linear approximation can be implemented using an add and shift method. For example, if log₂(1+f) is approximated by f+(f>>sh1)+(f>>sh2a)+ . . . +(f>>shn), the log₂(1+f) can be implemented as an add and shift architecture or an adder tree as shown in FIG. 4.

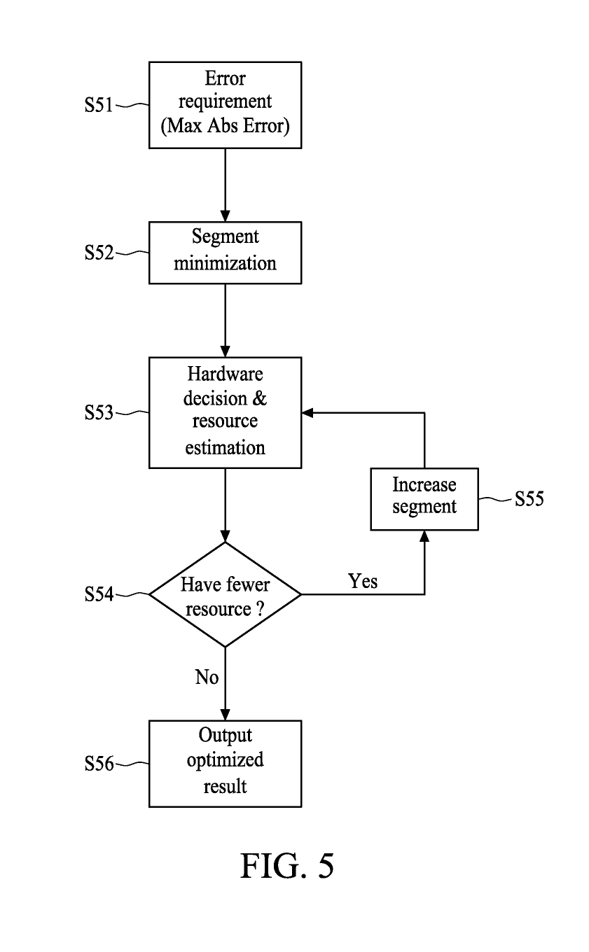

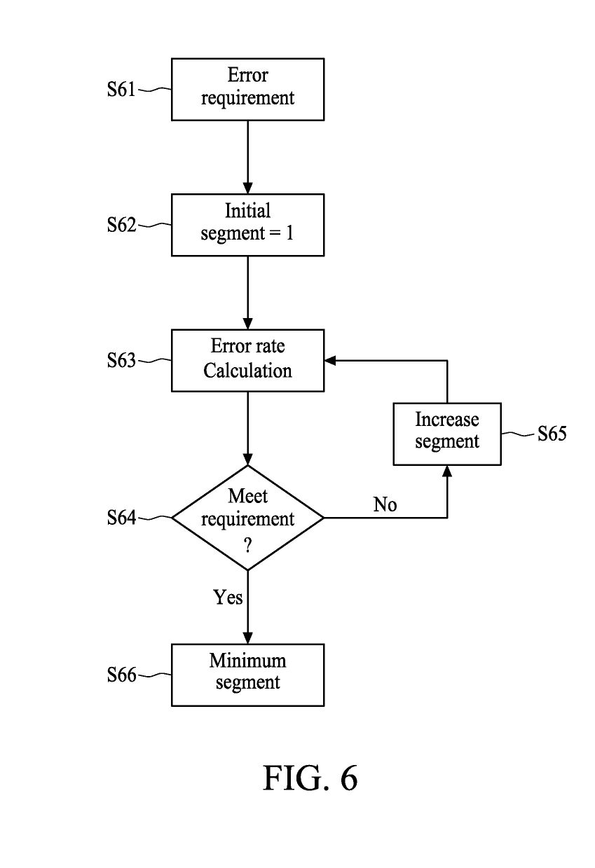

FIG. 5 is a flow chart showing a method for determining a logarithmic functional unit according to one embodiment of the present invention. FIG. 6 is a flow chart showing a method for determining a minimum segment number according to one embodiment of the present invention. Referring to FIG. 5, at Step S51, an error requirement or a threshold is provided.

At Step S52, a minimum segment number is determined. Referring to FIG. 6, at Step S61, an error requirement or a threshold is provided. The threshold can be very small, for example, 2⁻¹⁶. The linear approximation can be determined according to a paper by M. Zhu et al., entitled “Error Flatten Logarithm Approximation for Graphics Processing Unit,” in Proc. ICM, 2012, the relevant portion of which is incorporated herein for reference. The minimum segment number can be computed using a high precision simulation software, such as MATLAB.

At Step S62, an initial segment number of one is provided.

At Step S63, a testing piecewise linear approximation is determined and a corresponding approximation error is computed.

At Step S64, the approximation error is then compared with the threshold.

At Step S65, if the approximation error is greater than the threshold, the segment number is increased and the process moves back to Step S63. Steps S63 through S65 are repeated until a testing linear approximation having an approximation error smaller than the threshold is obtained and a corresponding segment number is used as the minimum segment number.

The error or approximation error can be determined by one of following equations:

$$\begin{matrix}error {=}^{Δ} {log}_{2} ( N ) - log {A}_{2} ( N ) & ( 3 ) \\ error range {=}^{Δ} max ( error ) - min ( error ) & ( 4 ) \\ present error {=}^{Δ} \frac{{log}_{2} ( N ) - log {A}_{2} ( N )}{{log}_{2} ( N )} \times 100 \% & ( 5 ) \\ present error {=}^{Δ} max ( pressent error ) - min ( present error ) & ( 6 ) \\ SNR ( db ) {=}^{Δ} 10 \times {log}_{10} ( \frac{{P}_{signal}}{{P}_{noise}} ) & ( 7 )\end{matrix}$$

where P_{signal} is a power of a signal and Pₙₒᵢₛₑ is P is a power of a noise.

For details on the calculation of the error or approximation error, refer to a paper by K. H. Abed and R. E. Sifred, entitled “CMOS VLSI implementation of a low power logarithmic converter,” IEEE Trans. On Computers, 2003, a paper by S. L. SanGregory et al., entitled “A fast, low power logarithm approximation with CMOS VLSI implementation,” in Proc. MWSCAS, 1999, a paper by T. B. Juang et al., entitled “A Lower Error and ROM-Free Logarithmic Converter for Digital Signal Processing Applications,” IEEE Trans. on Circuits and System-II: Express Briefs, 2009, and a paper by M. Zhu et al., entitled “Error Flatten Logarithm Approximation for Graphics Processing Unit,” in Proc. ICM, 2012.

Referring back to FIG. 5, at Step S53, the precision of the argument value f and the term number of expansion terms representing the fraction part of the function log₂(1+f) are varied to determine a less precise approximation representing log₂(1+f) having an approximation error less than a threshold. Thereafter, the less precise approximation is implemented as an implementation circuit, and the area of the implementation circuit is estimated.

At Step S54, the size of the area of a newly determined implementation circuit is compared with the size of the area of a former implementation circuit. If the size of the area of a newly determined implementation circuit is smaller, the process proceeds to Step S55; if the size of the area of a newly determined implementation circuit is larger, the process proceeds to Step S56. At Step S55, the segment number is increased by, for example, one, and then the process proceeds to Step S53. At Step S56, the newly determined implementation circuit is outputted.

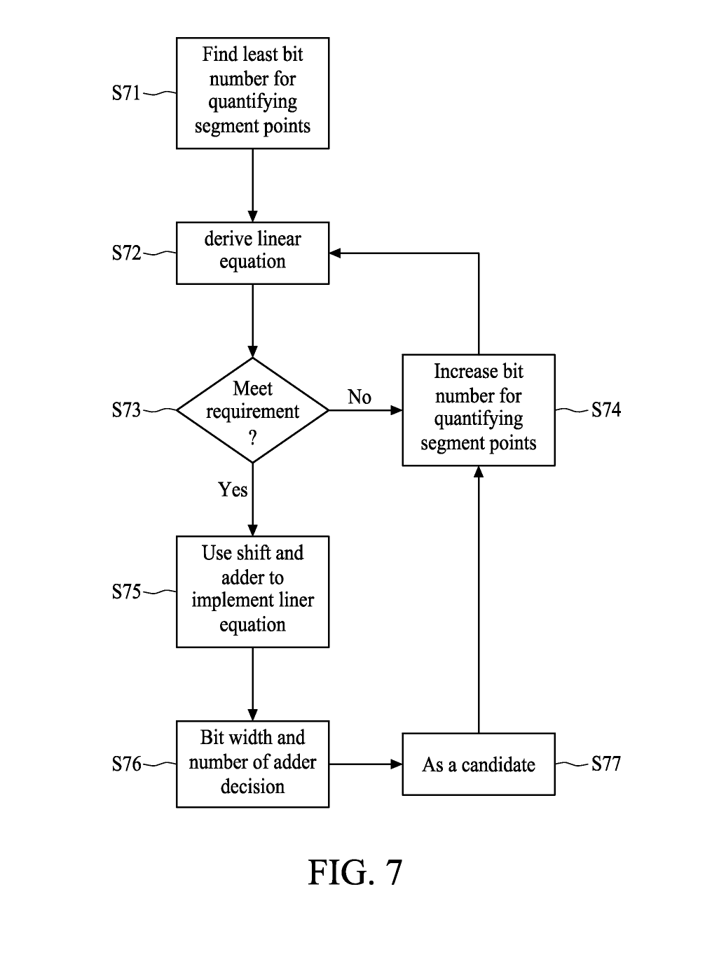

FIG. 7 is a flow chart showing a method for hardware decisions and resource estimations according to one embodiment of the present invention. Referring to FIG. 7, at Step S71, after the linear segment number is determined, a piecewise linear approximation for approximating a function for converting the fraction part of the function log₂(1+f) is accordingly determined. The piecewise linear approximation is on a plurality of intervals corresponding to the linear segment number. In one embodiment, the intervals can be uniform. In one embodiment, the intervals are not uniform.

In one embodiment, the piecewise linear approximation approximating function log₂(1+f), which is determined using a method disclosed in the paper by M. Zhu et al., has uniform output value ranges corresponding to the intervals. If the segment number is two, the piecewise linear approximation can be expressed as:

$$\{ \begin{matrix}1.2022 \times f + 0.0154 , & 0 \leq f < 0.4142 ( 8 a ) \\ 0.8502 \times f + 0.1633 , & 0.4142 \leq f < 1 ( 9 a )\end{matrix}$$

Next, suitable, less precise binary numbers are determined to respectively approximate endpoints of the intervals. To this end, a bit precision is initially determined. In one embodiment, the bit precision can be determined using a function ceil(log₂(number of segment)).

At Step S72, after the binary numbers or points for the endpoints of the intervals are determined, an adjusted piecewise linear approximation is determined on new intervals separated by the binary points.

At Step S73, the approximation error of the adjusted piecewise linear approximation is determined and compared with a threshold. The approximation error can be determined using one of the above equations (3) through (7). If the approximation error is greater than the threshold, the process proceeds to Step S72. If the approximation error is smaller than the threshold, the process proceeds to Step S75.

In one embodiment, the threshold compared with the approximation error of an adjusted piecewise linear approximation can be determined according to errors of previously published logarithm approximation methods such as errors disclosed in a paper by T. B. Juang et al., entitled “A Lower Error and ROM-Free Logarithmic Converter for Digital Signal Processing Applications,” IEEE Trans. on Circuits and System-II: Express Briefs, 2009.

In one embodiment, if two endpoints of the intervals are approximated by the same binary number, the bit precision is increased by one bit, and then a new adjusted piecewise linear approximation is re-calculated. The steps are repeated until no two endpoints of the intervals are approximated by the same binary number.

In one embodiment, the segment number is two and an adjusted piecewise linear approximation is expressed as:

$$\{ \begin{matrix}1.2210 \times f + 0.0129 , & 0 \leq f < 0.375 ( 8 b ) \\ 0.8609 \times f + 0.1547 , & 0.375 \leq f < 1 ( 9 b )\end{matrix}$$

At Step S75, the adjusted piecewise linear approximation is implemented as an add and shift architecture.

At Step S76, the adjusted piecewise linear approximation that has an approximation error less than the threshold is simplified to a less precise approximation that has an approximation error less than the threshold as well. The less precise approximation may use an argument value f of less precision and have less expansion terms for approximating the fraction of the function log₂(1+f) in comparison with the adjusted piecewise linear approximation. Accordingly, the less precise approximation can be implemented as an add and shift architecture smaller than that implemented from the adjusted piecewise linear approximation.

At Step S77, the less precise approximation is considered as a candidate linear approximation, and the process then proceeds to Step S74. Steps S72 through S77 are repeated until the precision of the binary endpoints or segment points exceeds a predetermined value.

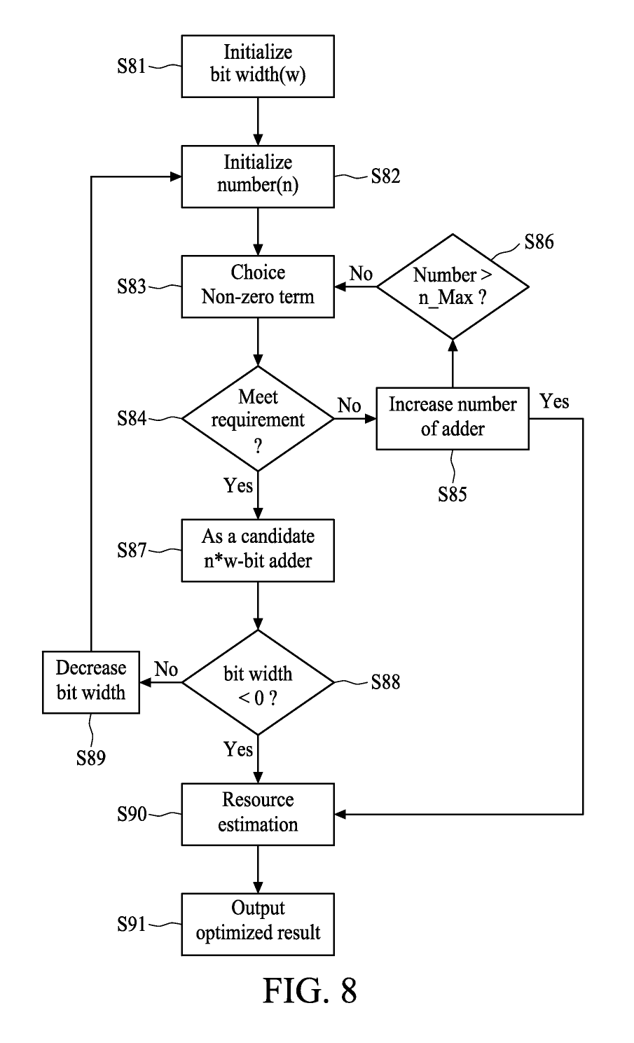

FIG. 8 is a flow chart showing a method for determining an adder bit-width and an adder number for an add and shift architecture according to one embodiment of the present invention. Referring to FIG. 8, after an adjusted piecewise linear approximation is determined, the coefficients of the adjusted piecewise linear approximation are encoded to convert the coefficients into binary forms. In one embodiment, the coefficients of the adjusted piecewise linear approximation are encoded to a canonical signed digit (CSD) form.

The system that includes an implemented add and shift architecture can have a precision of input. If the precision of input is m+n, the adder of an add and shift architecture can have a bit width of m+n−1. The maximum bit width of m+n−1 can be used to determine a predetermined bit number or an initial bit-width for the argument value of the adjusted piecewise linear approximation.

At Step S81, a bit-width w is initialized. The bit-width w is determined according to the bit-width of m+n−1.

At Step S82, a term or adder number n is initialized. In one embodiment, the term number n has an initial value of one. The term or adder number n determines the number of expansion term of the adjusted piecewise linear approximation used to approximate the fractional coefficient of the adjusted piecewise linear approximation.

At Step S83, the non-zero term(s) is selected according to the term or adder number n, and a temporary less precise approximation is determined according to the term number n and the precision of the argument value.

For example, an initial bit width is 17 bits and the equations (8b) and (9b) are encoded, and accordingly, the function log₂(1+f) can be approximated by:

$$\{ \begin{matrix}f + {( 0.0100 \overline{1} 000100101 )}_{2} \times f + {( 0.000000110101 )}_{2} , & 0 \leq f < 0.375 ( 10 ) \\ f - {( 0.00100100 \overline{1} 0100 \overline{1} 01 )}_{2} \times f + {( 0.001001111001101 )}_{2} , & 0.375 \leq f < 1 ( 11 )\end{matrix}$$

In the equation (10), if the term or adder number n is one, then the second most significant bit of the fractional coefficient of f is selected or reserved because the first most significant bit is zero. In the equation (11), the third most significant bit is selected or reserved because the first and second most significant bits are zero. As a result, a temporary less precise approximation can be obtained:

$$\{ \begin{matrix}f + {2}^{- 2} \times {f}_{15 MSBbit} + {0.0129}_{17 MSBbit} , & 0 \leq f < 0.375 ( 12 ) \\ f - {2}^{- 3} \times {f}_{14 MSBbit} + {0.1547}_{17 MSBbit} , & 0.375 \leq f < 1 ( 13 )\end{matrix}$$

where f_{15MSBbit} and f_{14MSBbit} respectively represent 15 MSB bits of f and 14 MSB bits of f.

At Step S84, an approximation error of the temporary less precise approximation is determined and compared with the threshold. In one embodiment, the threshold for the approximation error of an adjusted piecewise linear approximation can be determined according to errors of previously published logarithm approximation methods. If the approximation error of the temporary less precise approximation is greater than the threshold, the process proceeds to Step S85; if the approximation error of the temporary less precise approximation is less than the threshold, the process proceeds to Step S87.

At Step S85, the term or adder number is increased by, for example, one.

At Step S86, the increased term number is compared with a limit value n_Max. If the term number is smaller than the value n_Max, the process proceeds to Step S83, and the next non-zero term will be reserved. For example, if the term number is increased to two, the fifth most significant bit is reserved, and the next temporary less precise approximation will have two expansion terms.

If the term number is greater than the value n_Max, the argument value does not have a sufficient bit number or precision to allow a corresponding temporary less precise approximation to have an error approximation less than the threshold even though all expansion terms are applied. Under such a situation, the process proceeds to Step S90 and the last bit width is the least bit-width, and the temporary less precise approximation in computing is considered as a candidate linear approximation.

At Step S87, the temporary less precise approximation is considered as a candidate linear approximation. If there has been a candidate linear approximation, a newly determined temporary less precise approximation will replace the former one.

At Step S88, the bit-width is compared with zero. If the bit-width is greater than zero, the process proceeds to Step S89; if the bit-width is less than zero, the process proceeds to Step S90.

At Step S89, the bit-width is decreased by, for example, one, and the process proceeds to Step S82.

At Step S90, the candidate linear approximation is implemented as an implementation circuit.

At Step S91, the segment number is gradually increased, corresponding candidate linear approximations are determined, and the areas of the add and shift architectures of the corresponding candidate linear approximations are compared. Such process continues until an add and shift architecture having a minimum area is obtained.

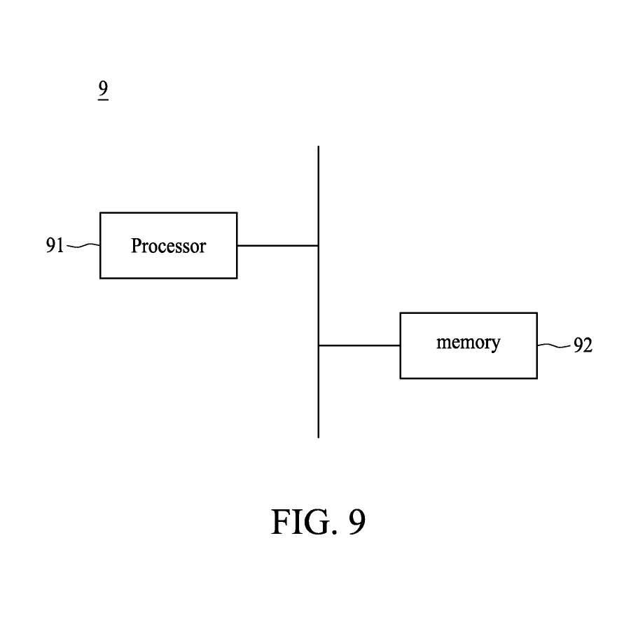

FIG. 9 schematically shows a hardware computer system 9 according to one embodiment of the present invention. Referring to FIG. 9, the hardware computer system 9 comprises a processor 91 and a memory 92. The memory comprises computer program code. The memory 92 and the computer program code are configured, with the processor 91, to cause the hardware computer system 9 to perform at least a portion of the steps of the above methods.

In at least some embodiments, a method of the present disclosure changes the bit width of an argument of a piecewise linear approximation and the number of expansion term of the piecewise linear approximation to obtain a less precise approximation that has an error less than a threshold and can be implemented as a circuit consuming a small area. In at least some embodiments, the method changes the precision of segment points to obtain a circuit that consume less area and generate more precise results. In at least one embodiment, the method increases the number of segmentation until a circuit consumes the least area is obtained.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The above-described embodiments of the present invention are intended to be illustrative only. Those skilled in the art may devise numerous alternative embodiments without departing from the scope of the following claims.

What is claimed is:

1. A hardware implemented method for determining a logarithmic functional unit, comprising:
A) providing a segment number;
B) using the segment number to determine a piecewise linear approximation on a plurality of corresponding intervals for approximating a function for converting a fraction;
C) providing a bit precision;
D) converting endpoints separating the plurality of intervals to corresponding binary endpoints separating an additional plurality of intervals in the bit precision;
E) determining an adjusted piecewise linear approximation that has an approximation error less than a threshold and is on the additional plurality of intervals;
F) encoding coefficients of the adjusted piecewise linear approximation;
G) determining a less precise approximation from the adjusted piecewise linear approximation as a candidate linear approximation, wherein the less precise approximation uses an argument value having a least bit-width while still being able to have an approximation error less than the threshold; and
H) implementing the less precise approximation to obtain an implementation circuit.

2. The method of claim 1, wherein the step of determining a less precise approximation comprises:
I) setting the argument value of the adjusted piecewise linear approximation to a precision of a predetermined bit number;
J) providing a term number;
K) determining a temporary less precise approximation according to the term number and the setting argument value;
L) increasing the term number if the temporary less precise approximation has an approximation error greater than the threshold;
M) repeating the steps K) and L) until a temporary less precise approximation having an approximation error less than the threshold is obtained or the term number is greater than a limit value;
N) using the temporary less precise approximation having the approximation error less than the threshold as the less precise approximation;
O) decreasing the precision of the argument value; and
P) repeating the steps J) through O) until the precision of the argument value is zero.

3. The method of claim 1, further comprising:
Q) increasing the segment number by one;
R) performing the steps B) through H); and
S) repeating the steps Q) and R) until an implementation circuit having a minimum area is obtained.

4. The method of claim 1, further comprising a step of increasing the bit precision and performing the steps of D) through G) to determine another approximation as the candidate linear approximation.

5. The method of claim 4, wherein the step of increasing the bit precision and performing the steps of D) through G) is performed until a precision of the binary points exceeds a predetermined value.

6. The method of claim 1, further comprising a step of increasing the bit precision if two of the endpoints are approximated by a same binary endpoint.

7. The method of claim 1, wherein the step of providing a segment number comprises:
setting the segment number to one;
determining a testing piecewise linear approximation using the segment number;
increasing the segment number if the testing piecewise linear approximation has an approximation error greater than another threshold; and
repeating the steps of determining a testing piecewise linear approximation and increasing the segment number until the testing piecewise linear approximation has the approximation error less than the threshold.

8. The method of claim 1, wherein the piecewise linear approximation has uniform output value ranges corresponding to the intervals.

9. The method of claim 1, wherein the step of encoding coefficients of the adjusted piecewise linear approximation comprises a step of encoding coefficients of the adjusted piecewise linear approximation to a canonical signed digit form.

10. The method of claim 1, wherein the bit precision is determined by ceil(log₂(the segment number)).

11. A computer program product comprising a non-transitory computer-readable medium bearing computer program code embodied therein for causing a hardware computer system to:
A) provide a segment number;
B) use the segment number to determine a piecewise linear approximation on a plurality of corresponding intervals for approximating a function for converting a fraction;
C) provide a bit precision;
D) convert endpoints separating the plurality of intervals to corresponding binary endpoints separating an additional plurality of intervals in the bit precision;
E) determine an adjusted piecewise linear approximation that has an approximation error less than a threshold and is on the additional plurality of intervals;
F) encode coefficients of the adjusted piecewise linear approximation;
G) determine a less precise approximation from the adjusted piecewise linear approximation as a candidate linear approximation, wherein the less precise approximation uses an argument value having a least bit-width while still being able to have an approximation error less than the threshold; and
H) implement the less precise approximation to obtain an implementation circuit.

12. The computer program product of claim 11, wherein the computer program code causing the hardware computer system to determine a less precise approximation comprising the computer program code causes the hardware computer system to:
I) set the argument value of the adjusted piecewise linear approximation to a precision of a predetermined bit number;
J) provide a term number;
K) determine a temporary less precise approximation according to the term number and the setting argument value;
L) increase the term number if the temporary less precise approximation has an approximation error greater than the threshold;
M) repeat the steps K) and L) until a temporary less precise approximation having an approximation error less than the threshold is obtained or the term number is greater than a limit value;
N) use the temporary less precise approximation having the approximation error less than the threshold as the less precise approximation;
O) decrease the precision of the argument value; and
P) repeat the steps J) through O) until the precision of the argument value is zero.

13. The computer program product of claim 11, wherein the computer program code further causes the hardware computer system to:
Q) increase the segment number by one;
R) perform the steps B) through H); and
S) repeat the steps Q) and R) until an implementation circuit having a minimum area is obtained.

14. The computer program product of claim 11, wherein the computer program code further causes the hardware computer system to increase the bit precision and perform the steps of D) through G) to determine another approximation as the candidate linear approximation.

15. The computer program product of claim 14, wherein the computer program code causing the hardware computer system to increase the bit precision and perform the steps of D) through G) comprises the computer program code causing the hardware computer system to increase the bit precision and perform the steps of D) through G) until a precision of the binary points exceeds a predetermined value.

16. The computer program product of claim 11, wherein the computer program code further causes the hardware computer system to increase the bit precision if two of the endpoints are approximated by a same binary endpoint.

17. The computer program product of claim 11, wherein the computer program code causing the hardware computer system to provide a segment number comprising the computer program code causes the hardware computer system to:
set the segment number to one;
determine a testing piecewise linear approximation using the segment number;
increase the segment number if the testing piecewise linear approximation has an approximation error greater than another threshold; and
repeat the steps of determining a testing piecewise linear approximation and increasing the segment number until the testing piecewise linear approximation has the approximation error less than the threshold.

18. The computer program product of claim 11, wherein the piecewise linear approximation has uniform output value ranges corresponding to the intervals.

19. The computer program product of claim 11, wherein the computer program code causing the hardware computer system to encode coefficients of the adjusted piecewise linear approximation comprises the computer program code causing the hardware computer system to encode coefficients of the adjusted piecewise linear approximation to a canonical signed digit form.

20. The computer program product of claim 11, wherein the bit precision is determined by ceil(log₂(the segment number)).
